(19) United States
(12) Patent Application Publication
(10) Pub. No.: US 2020/0286196 A1
(43) Pub. Date: Sep. 10, 2020

(54) SYSTEM AND METHOD FOR INTELLECTUAL PROPERTY FINANCING

(71) Applicants: ERICH LAWSON SPANGENBERG, PARIS (FR); DANIEL LAWRENCE BORK, EAST KINGSTON, NH (US); PASCAL ASSELOT, PARIS (FR)

(72) Inventors: ERICH LAWSON SPANGENBERG, PARIS (FR); DANIEL LAWRENCE BORK, EAST KINGSTON, NH (US); PASCAL ASSELOT, PARIS (FR)

(21) Appl. No.: 16/747,326

(22) Filed: Jan. 20, 2020

Related U.S. Application Data
(60) Provisional application No. 62/804,127, filed on Feb. 11, 2019.

(51) Int. Cl. G06Q 50/18; G06Q 20/06; G06Q 10/10; G06Q 20/12; G06Q 40/04; G06Q 40/08; G06N 5/02; G06F 16/903; H04L 9/32

(52) U.S. Cl. CPC G06Q 50/184; G06Q 20/0655; G06Q 10/10; G06Q 20/1235; G06Q 40/04; G06Q 2220/123; G06N 5/02; G06F 16/90335; H04L 9/32; G06Q 2220/18; G06Q 40/08

(57) ABSTRACT

The invention is a decentralized and autonomous market for intellectual property financing. Through the use of a blockchain network and complex algorithms, the platform will allow intellectual property owners to present their registrations and secure funding based on the strength of their intellectual property assets. Importantly, the system can use historical data to provide complex metrics to both investors and business owners and reduce the risks associated with such a relationship.

### PRIORITY CLAIMS

This application claims the benefit of U.S. Provisional Patent Application Ser. No. 62/804,127 filed on Feb. 11, 2019, and is incorporated herein by reference.

### BACKGROUND OF THE INVENTION

Experts say that ideas and intellectual property have become the chief source of wealth in the Knowledge Economy, comprising 80% of the value of public companies today. However, the lack of a system that connects valuable intellectual property to financial investors has limited the use of these valuable assets to a defensive mechanism.

Interestingly, an accessible, efficient, and viable system of financing secured on intellectual property assets does not exist. The reason behind the lack of such a system requires an understanding the current landscape around securing financing. Specifically, the current trends regarding business investment revolve around securing outside capital based on a business plan or product revenue. However, it is clear that securing such capital is difficult. In fact, a survey recently released by Ernst & Young found that over 66% of more than 1,000 entrepreneurs found it difficult to gain access to the capital they needed to grow.

At the most basic level, there are two sources of funding for a growing business: lenders who loan money for a period of time and look to get repaid with a return, and investors looking to buy a piece of a company in return for long-term capital gains when the price of your stock increases. Lenders, as a rule, are not interested in a vision for a great business. They are solely interested in risk management and the capacity of a business to repay the credit that they advance.

Another issue that businesses face while accessing funds and financing is the problem of uncertainty. A business is seriously handicapped by lack of past record that potential lenders can analyze to determine whether or not to furnish the small business with the required fund needed for expansion. Accordingly, it can be extremely difficult to get credit as a small business. The fact is, most small businesses fail. Lenders know this. Thus, to successfully raise debt financing for a business, one needs to first have a financial plan that will allow for debt repayment. For this reason, debt is not usually the first outside capital to go into a business.

Compounding the problem further is the fact that banks and other financial institutions cannot get useful information that will give them insight into the activities of a potential business's debtor. Accordingly, they force businesses to provide a detailed business plan, list of the firm's assets, detail the experience of directors and managers and show how they intend to provide security for the sums advanced. This process rarely if ever provides the appropriate expertise needed to evaluate any intellectual property assets. As a result, many businesses end up in an entangled position. Entangled position is used to describe a situation where banks are unwilling to increase credit facility without a corresponding increment in security (collateral) from the part of the small business that in turn may be unwilling or unable to make such increment. Some banks even require that the owners' equity in the business be increased before further credit line be given. As such, a business owner must have assets that the lenders can take as security as collateral to any loan. The most common assets are receivables that are less than 90 days old and inventory. When you are starting out you may also have to give personal guarantees. In addition, traditional lenders are restricted in geographic region, and do not contemplate lending on strategic intellectual property. Moreover, banks and other financial institutions tend to ask for personal guarantees from owners of small businesses and will set interest rates at higher levels than those charged to big and established companies.

It is particularly difficult for small companies to obtain medium term loans due to a mismatching of the maturity of assets and liabilities. Longer term loans are easier to obtain than the medium- and short-term loans. The reason is because longer term loans are secured with mortgages against property. Unfortunately, few businesses can secure property without first securing lending.

The equity investor side is even tougher to navigate. Investors come in all shapes and sizes and have differing objectives. The challenges entrepreneurs face in raising equity boil down to the same root cause as debt—failing to understand the needs of investors.

Angel investors as an example are looking for businesses that can quickly get to cash flow positive. Venture capitalists are looking for businesses that can go grow very quickly and become very large and valuable. Additionally, it is extremely difficult to find any wealthy person that will be sincerely willing to invest in small company when they are likely to be more attractive investment opportunities from bigger and more attractive firms.

The stock market may not have confidence in small businesses' offer. Even when they have, they tend to lay or attach little value to it and this will make the firm to issue out more number of shares (just to raise little amount) that will in turn further dilute the small company's earnings.

And, of course, all equity investors are looking for an exit strategy. There must be a method of selling the shares of an investment at a higher price in the future. This is another source of friction with entrepreneurs. If you are planning to run your business for the rest of your life, don't try to raise outside capital. After all, most business owners are not looking to sell their business.

Even those investors willing to invest in business face significant challenges. Inherently, those investing in business are seeking to make a valuable return on their investment. However, it is difficult and expensive to evaluate the assets of a business. Accordingly, investors tend to shy away from ventures without confirming business plans. Moreover, they require strict adherence to milestones and other criterion that often hamper the business itself.

While both investors and businesses understand the importance that intellectual property can play in the success of a business, the valuate of said assets requires significant historical data, and a unique expertise that is difficult to find. There are further no ways to divest from a venture without causing significant disturbance in a manner that may effect the business itself.

The few investors available are further hampered by the limitations of a geographically restricted economy. Investments must take the form of specific FIAT currency, and sales must meet strict adherence to procedure defined by regulatory authority that does not comprehend the needs of the business or the investor.

### SUMMARY OF THE INVENTION

The present invention pertains to a platform that could evaluate and connect owners of intellectual property to financing could solve many of the problems surrounding the securing of financing.

Intellectual property financing surrounds the idea of using intellectual property assets as the basis to secure investment in a business. In particular, a decentralized approach to evaluation could provide access to historical data, and a risk metric that will allow investors to bid on assets. The goal of the present invention is to create a new framework, which will facilitate efficient financing of protected intellectual property. What this means is that accredited investors, from a variety of industries, will now gain access to a previously inaccessible asset class. This will allow companies a new opportunity to obtain financing based on the significant investments they've made into their intellectual property and the strength of their patent portfolio. Today, a very high percentage of companies' balance sheets are intangibles.

As such, there are incredible macro and micro benefits that extend from bringing liquidity to the intellectual property asset class. In addition, the platform can offer investors the opportunity to access this non-correlated asset class, giving them an opportunity for efficient private market secondary liquidity.

Some of the methods by which to attract investors may include: offering a high yield rate; setting specific term limits; secured patent portfolios that provide three times the normal coverage with potential additional credit enhancements; include warrant coverage; and permit the lender to trade out through a token based system.

Using a blockchain or decentralized ledger, the present invention discloses a platform that can both evaluate patents, and provide access to said patents to investors. Through the use of cryptocurrency and virtual tokens, the platform connects persons on a global level. An artificial intelligence component provides an evolving platform that collets analyzes computes and adapts to the ever-changing environment.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 is an overview diagram of the present invention.

FIG. 2 is an overview of the partner solutions of the present invention.

FIG. 3 is a diagram of the smart securities process for patent assets using the present invention.

### DETAILED DESCRIPTION OF THE PREFERRED EMBODIMENT

Today, the patent finance market is highly illiquid and relatively small. At one end of the spectrum are the “lenders of last resort” that focus on “loan-to-own” transactions. These “lenders” often fund at effective rates of 300%, with the hope that they can foreclose and own the patents. A business with any other alternatives simply avoids these lenders.

At the other end of the spectrum are large asset-based lenders that lump patent portfolios with many other assets into the collateral. In this situation, little to no value is ascribed to the patents and taking a security interest in patent portfolios is nothing more than a box checking exercise.

There are financing transactions that occur between these two models, but they are either relatively small financings or are typically associated with monetization and assertion campaigns that are not viable options for many patent owners.

Through the use blockchain technology, the present invention seeks to disclose a decentralized platform that provides a cost effective platform for securing financing secured by intellectual property assets.

Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.¹ ¹“Ethereum Whitepaper,” http://github.com/ethereum/wiki/wiki/white-paper, 2016

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct amount of tokens to and from the correct accounts.

The blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract.

The smart contract may determine the rules for evaluating a token price and an initial status of the token (such as the reserve of the token) and any other rules that should be applied during a transaction.

The platform itself can construct a smart contract in real time based on inputs generated from artificial intelligence. In particular, the platform allows for a user to register intellectual property, and interprets historical data regarding the value of such assets using complex algorithms using either statistical approaches or artificial intelligence and neural networks.

In one embodiment, the platform can provide IP rating which can be a factor used to determine a credit rating for an owner. Moreover, using complex algorithms and artificial intelligence and neural networks, the platform can propose a relative value for the intellectual property if properly used.

With a smart contract, the platform can potentially provide the terms of the investment, that will be self-executed, including the rate, the length, and conditions for sale. With respect to sale, an investor looking to exit a particular investment can divest by selling virtual currency, resulting in a minimum impact to the business. Stated otherwise, the platform can provide a market for investors to invest in intellectual property assets and trade said investments as needed.

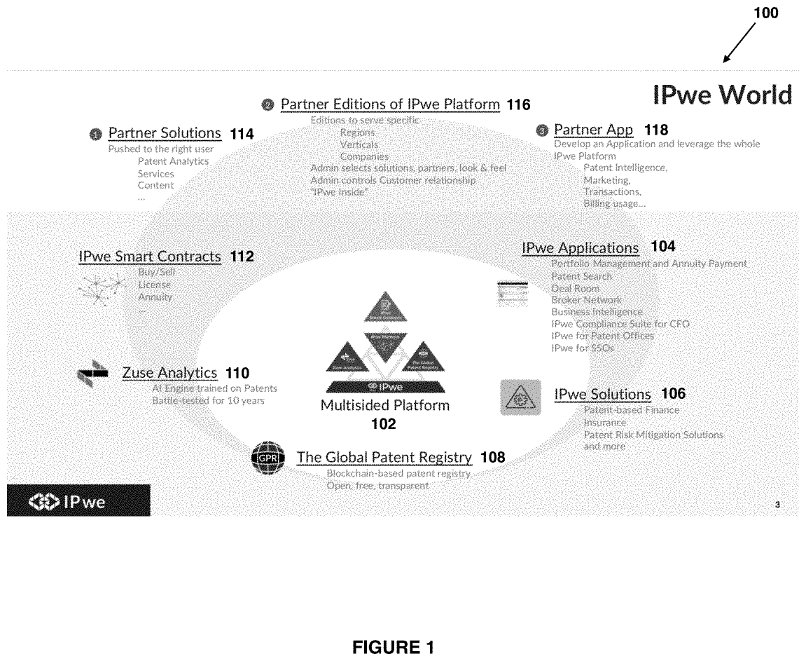

FIG. 1 is an overview diagram of the present invention. In accordance with the preferred embodiment of the present invention, the platform 102 is multisided and incorporates a network of sources 100. The platform 102 incorporates an applications program 104 that provides services including: portfolio management; annuity payments; patent searching; a patent brokerage network and deal room; and compliance guides. The platform 102 also includes a solutions program 106 that can provide patent-based finance, insurance and risk mitigation solutions. The Global Patent Registry 108 is a blockchain based patent registry available to the platform user. The platform 102 also utilizes an AI analytics engine 110, and a smart contracts program 112 that can generate to buy or sell patents, license patents and handle patent annuities. The platform 102 is powered by a blockchain, such as the IBM Hyperledger, which allows the deployment of smart contracts to buy, sell and license IP assets. Importantly, this functionality provides the additional feature of valuating assets, and connecting potential business owners to investors. Additional resources utilized by the present invention include partner solutions 114, partner editions of the platform 116, and partner applications 118. Partner solutions 114 include providing patent analytics, services and content to partners. Partner editions of the platform 116 are customized platform elements to serve specific regions, verticals and companies, and provide enhanced platform administrator controls. Partner applications 118 allow for further development of applications and leverage through the platform using patent intelligence, marketing, transactions and billing usage. FIG. 1 further illustrates that a battle tested engine such as Zuse analytics 110 can work in conjunction with the platform to analyze applications, and connect with partner applications 118. The partner editions of the platform can further server specific verticals, companies, regions, and provide an admin control. Finally, the solutions allow for finance, insurance, and risk mitigation solutions.

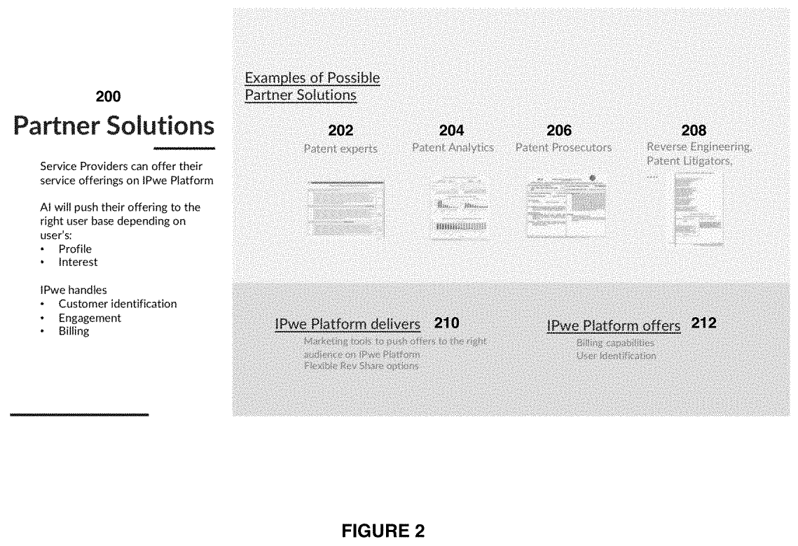

FIG. 2 is an overview of the partner solutions 200 of the present invention. In another embodiment, as shown in FIG. 2, the platform can connect with additional partner solutions 200, which allow for the user base to create a profile, show interest in various intellectual property offerings, provide for identification, engagement, and billing tools. The platform can then provide access to experts 202, analytics 204, legal teams and patent prosecutors 206, and reverse engineering litigators 208 who can provide input to the valuation process. This allows the platform to deliver marketing tools to the appropriate audience, and flexible revenue sharing options 210. Finally, the platform will allow for billing opportunities and verified identification 212.

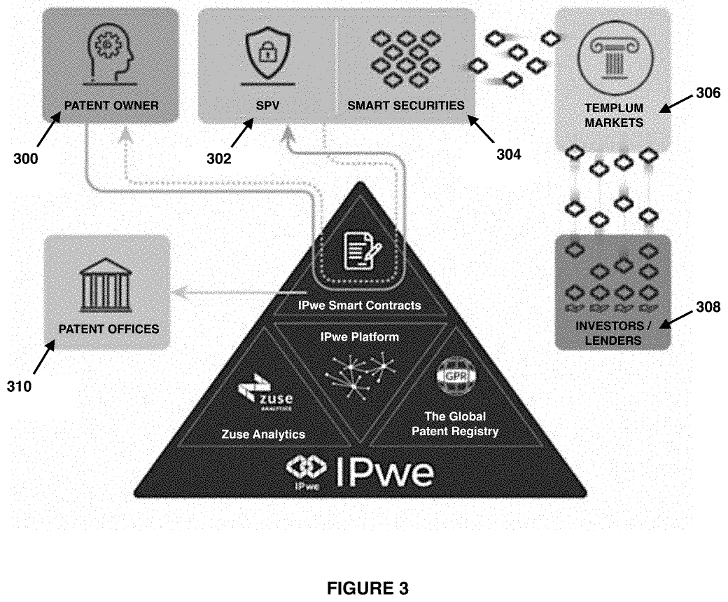

FIG. 3 is a diagram of the smart securities process for patent assets using the present invention. A patent owner 300 can establish an SPV 302 for smart securities 304 related to patent assets. Templum Markets 206 can organize the securities 304. Investor lenders 308 can purchase insurance on title at the time of purchase. Patent Offices 310 can be used to verify the color of title.

The platform itself can construct a smart contract in real time based on inputs from an inventor or patent holder. In one embodiment, the inventor submits the patent application, and the network uses an analysis engine to generate a report regarding the likelihood of patentability based on several criteria, including patentable nature of the invention, the status of prior art, and the novelty of the inventive step. The platform further provides a user to express interest in insurance, and provides a rate and insurance premium price using FIAT currency and virtual currency. The user can select the options that seem most beneficial to the user at that time.

In another embodiment, as shown in FIG. 3, the patent owners utilize smart contracts to form a special purpose vehicle with smart securities. The use of third-party partners such as Templum markets organizes the liquidity of investors the smart securities among lenders and investors. The platform provides direct access to the patent offices in a decentralized manner. In addition, battle tested engines such as zuse analytics allows an investor to be better informed. Finally, a global patent registry is formed wherein a patent owner can pledge a patent to lenders and investors. The platform provides relevant tools such as research, annuity payments, analysis, analytics, transactional support, title verification, portfolio management, and licensing strategy.

In another embodiment, the platform allows investors to contemplate investment in patent insurance to mitigate the risk associated with litigation and loss of intellectual property rights.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

What is claimed is:

1. A system for transacting intellectual property rights comprising:
a blockchain communication medium for capturing and disseminating information related to the scope and validity of said intellectual property rights;
a broadcasting interface connected to said blockchain medium for original holders of said intellectual property rights to create a market for said rights;
a multiplicity of receiver interfaces connected to said blockchain medium for prospective holders of said intellectual property rights to evaluate said rights for the purpose of deciding whether said prospective holders will acquire an interest in said intellectual property rights by creating a final decision; and
an intelligent evaluation technique provided by an intellectual property asset class manager for assisting said prospective holders of said intellectual property rights as to whether said prospective holders will acquire said intellectual property rights from said original holders of said intellectual property rights by way of said final decision based on said scope and said validity of said intellectual property rights.

2. A system according to claim 1 wherein said rights are licensing rights.

3. A system according to claim 1 wherein said rights are ownership rights.

4. A system according to claim 1 wherein said intelligent evaluation techniques utilize artificially intelligent data evaluation engines.

5. A system according to claim 1 wherein said holder and said prospective holders of intellectual property rights transact business by way of cryptocurrency.

6. A system according to claim 5 wherein said business transacted is transacted by way of a smart blockchain contract.

7. A system according to claim 1 for intellectual portfolio management for said holders and said prospective holder of intellectual property rights including making annuity payments, searching said intellectual property rights, brokering said intellectual property rights and providing a deal interface pursuant to applicable compliance guidelines.

8. A system according to claim 7 wherein patent-based finance, insurance and risk mitigation solutions are provided for said holders of intellectual property rights.

9. A method for transacting intellectual property rights comprising the steps of:
forming a blockchain communication medium for capturing and disseminating information related to the scope and validity of said intellectual property rights;
broadcasting via an interface connected to said blockchain medium information pertaining to said intellectual property rights from original holders of said intellectual property rights to create a market for said rights;
formatting a multiplicity of receiver interfaces connected to said blockchain medium for prospective holders of said intellectual property rights to evaluate said rights for the purpose of deciding whether said prospective holders will acquire an interest in said intellectual property rights by creating a final decision; and
performing an intelligent evaluation technique provided by an intellectual property asset class manager for assisting said prospective holders of said intellectual property rights as to whether said prospective holders will acquire said intellectual property rights from said original holders of said intellectual property rights by way of said final decision based on said scope and said validity of said intellectual property rights.

10. A method according to claim 9 wherein said rights are licensing rights.

11. A method according to claim 9 wherein said rights are ownership rights.

12. A method according to claim 9 wherein said intelligent evaluation techniques utilize artificially intelligent data evaluation engines.

13. A method according to claim 9 wherein said holder and said prospective holders of intellectual property rights transact business by way of cryptocurrency.

14. A method according to claim 13 wherein said business transacted is transacted by way of a smart blockchain contract.

15. A method according to claim 9 for intellectual portfolio management for said holders and said prospective holder of intellectual property rights including making annuity payments, searching said intellectual property rights, brokering said intellectual property rights and providing a deal interface pursuant to applicable compliance guidelines.

16. A method according to claim 15 wherein patent-based finance, insurance and risk mitigation solutions are provided for said holders of intellectual property rights.
